(19) United States
(12) Patent Application Publication
(10) Pub. No.: US 2026/0328605 A1
(43) Pub. Date: Oct. 22, 2026

(54) PAVER PAYLOAD DEPOSIT ESTIMATE USING AUGER DRIVE POWER

(71) Applicant: Caterpillar Paving Products Inc., Brooklyn Park, MN (US)

(72) Inventors: Matthew Thomas HANSON, St. Louis Park, MN (US); Austin BIES, Saint Louis Park, MN (US); Jacob J. McALPINE, Otsego, MN (US); John Lee MARSOLEK, Watertown, MN (US)

(73) Assignee: Caterpillar Paving Products Inc., Brooklyn Park, MN (US)

(21) Appl. No.: 19/183,736

(22) Filed: Apr. 18, 2025

(51) Int. Cl. G01F 1/86; B65G 65/46; E01C 19/48

(52) U.S. Cl. CPC G01F 1/86; B65G 65/46; E01C 19/4873; E01C 2301/00

(57) ABSTRACT

A paver or remote computer may receive one or more sensor measurements corresponding to operating the paver. The paver or remote computer may determine, in accordance with the one or more sensor measurements, a drive power associated with operating an auger of the paver. The paver or remote computer may determine a mass of a material deposited by the paver in accordance with the drive power associated with operating the auger of the paver. The paver or remote computer may output a mass indication indicating the mass of the material deposited by the paver.

### TECHNICAL FIELD

The present disclosure relates generally to a paver and, for example, to estimating an amount of material deposited by a paver.

### BACKGROUND

Asphalt paving is a process where a mixture (also called an “asphalt mixture”) of bitumen (asphalt) and aggregates, such as sand, gravel, or crushed stone, is applied to a surface to form a durable and smooth pavement. The asphalt mixture may be heated, transported, and spread on a prepared surface, such as a roadbed or driveway, and subsequently compacted to achieve a desired thickness and density. A paver is a machine that applies the paving material, such as the asphalt mixture, onto the prepared surface as a compacted mat. The paver may include a hopper for receiving paving material, a distribution system for spreading the material, and a screed for leveling and compacting the material to achieve a desired thickness and surface finish for the compacted mat.

U.S. Pat. No. 5,484,226 (the '226 patent) discloses automated controls of an asphalt paver wherein the speed of the conveyor is automatically controlled at a rate proportional and responsive to the speed of the auger and the conveyer is free from having a material sensor and speed control responsive thereto. While the '226 patent discloses some benefits, the apparatus, system, and method of the present disclosure are associated with other benefits, such as determining an amount of paving material deposited onto a paving surface in accordance with a drive power of the auger.

### SUMMARY

A method may include receiving one or more sensor measurements corresponding to operating a paver; determining, in accordance with the one or more sensor measurements, a drive power associated with operating an auger of the paver; determining a mass of a material deposited by the paver in accordance with the drive power associated with operating the auger of the paver; and outputting a mass indication indicating the mass of the material deposited by the paver.

An apparatus may include a hopper for storing a paving material; an auger configured to deposit the paving material onto a paving surface; a conveyor configured to transport the paving material from the hopper to the auger; a screed plate configured to compact the paving material on the paving surface; one or more sensors configured to measure one or more sensor values; an interface device; one or more memories; and one or more processors, coupled to the one or more memories, configured to: determine a mass of the paving material deposited onto the paving surface in accordance with a drive power associated with operating the auger; and output, to the interface device, a mass indication indicating the mass of the paving material deposited onto the paving surface.

A system may include one or more memories; and one or more processors, coupled to the one or more memories, configured to: receive one or more sensor measurements corresponding to operating a paver; determine, in accordance with the one or more sensor measurements, a drive power associated with operating an auger of the paver; determine a mass of a material deposited by the paver in accordance with the drive power associated with operating the auger of the paver; and output a mass indication indicating the mass of the material deposited by the paver.

### BRIEF DESCRIPTION OF THE DRAWINGS

FIG. 1 is a diagram associated with an example paver for depositing paving material onto a paving surface.

FIG. 2 is a diagram of an example system associated with estimating an amount of paving material being deposited onto the paving surface.

FIG. 3 is a diagram of an example system, of a remote computer associated with estimating an amount of paving material being deposited onto the paving surface by the paver.

FIG. 4 is a flowchart of an example process associated with estimating the amount of paving material being deposited onto the paving surface based on an auger drive power.

### DETAILED DESCRIPTION

This disclosure relates to estimating an amount of paving material deposited onto a paving surface, which is applicable to one or more construction machines. For example, the construction machine may be a paving machine (e.g., “paver”).

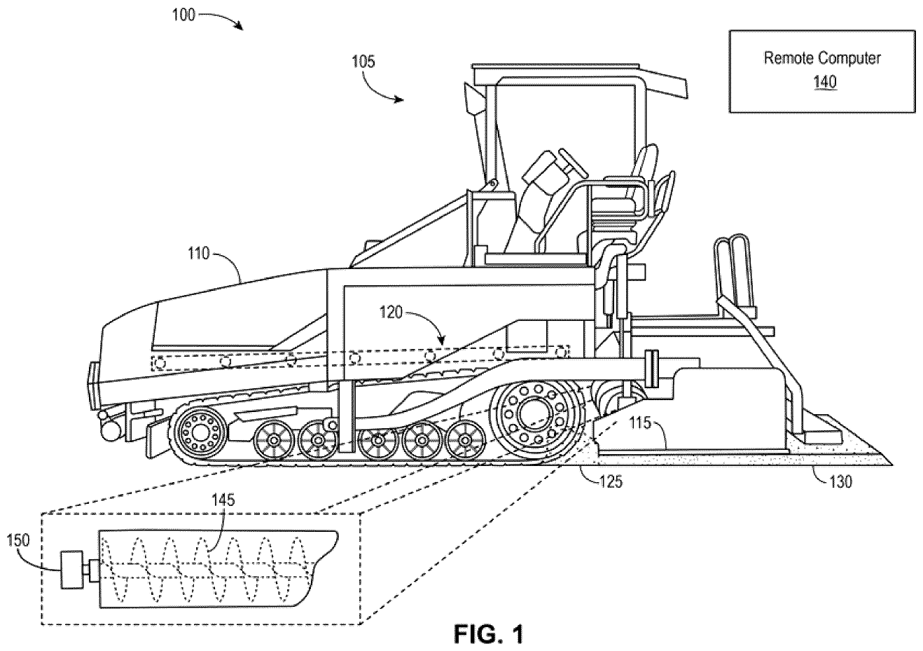

FIG. 1 is a diagram associated with an example paver 100 for depositing a paving material onto a paving surface. As shown in the example of FIG. 1, the paver 100 may include a tractor 105 that includes a front-mounted hopper 110 and a screed plate 115. A conveying system 120 having belts, chains, and/or augers may be configured to transport material (e.g., a hot asphalt mixture 125) from the hopper 110 to the screed plate 115. For example, the conveying system 120 may include a conveyor belt, rollers, and an auger 145. The auger 145 may be configured to rotate in accordance with rotation of an auger drive motor 150 to deposit the asphalt mixture 125 onto the paving surface ahead of the screed plate 115. The screed plate 115 may be configured to level and shape the asphalt mixture into a layer (e.g., a compacted mat 130) having a desired thickness and width. For example, the screed plate 115 may be configured to compact the asphalt mixture 125 into the compacted mat 130 parallel to the paving surface. The screed plate 115 may include an electric heater that heats the asphalt mixture 125.

As discussed in greater detail below, the paver 100 may include a system for determining a mass of the asphalt mixture 125 deposited onto the paving surface. For example, the system may determine the mass of the asphalt mixture 125 in accordance with one or more sensor measurements, such as a drive power associated with operating the auger 145 used to move the asphalt mixture 125 from the hopper 110 to the screed plate 115. The system may output, to an operator of the paver 100, a mass indication that indicates a mass of the asphalt mixture 125 being deposited onto the paving surface. Alternatively or in addition, the paver 100 may transmit information to a remote computer 140, and the remote computer 140 may be configured to determine the amount of paving material being deposited onto the paving surface. As indicated above, FIG. 1 is provided as an example. Other examples may differ from what is described with regard to FIG. 1.

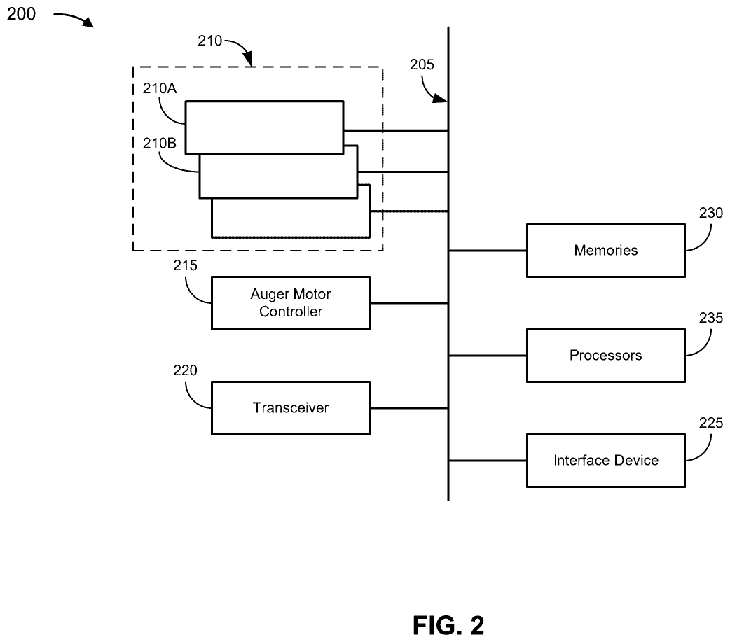

FIG. 2 is a diagram of an example system 200 associated with estimating an amount of paving material being deposited onto a paving surface. As shown in FIG. 2, the paver 100 includes a bus 205, one or more sensors 210, an auger motor controller 215, a transceiver 220, an interface device 225, one or more memories 230, and one or more processors 235, among other examples. The components of the system 200 of FIG. 2 may be in communication with one another via the bus 205. The one or more memories 230 and the one or more processors 235 may be part of a controller of the paver 100.

The bus 205 may include one or more components that enable wired and/or wireless communication among the components of the paver 100. The bus 205 couples together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus.

The one or more sensors 210 may be configured to detect or measure one or more characteristics of the auger 145, the paving material, the paver 100, or a combination thereof, among other examples. For example, the one or more sensors 210, individually or collectively, may be configured to measure a hydraulic pressure (e.g., a hydraulic pressure associated with operating the auger 145), a flow rate of a hydraulic fluid (e.g., the hydraulic fluid used to operate the auger 145), a motor current (e.g., an amount of electric current drawn by an electric auger drive motor 150), a motor speed (e.g., a rotational speed of the auger drive motor 150), an auger speed (e.g., a rotational speed of the auger 145), a temperature (e.g., a temperature of the paving material before and/or after being heated by the screed plate 115), a weight (e.g., a weight of the paving material), a speed (e.g., a speed of the paver 100), an orientation (e.g., an orientation of the screed plate 115 relative to the paving surface), an angle (e.g., an angle of the paver 100 relative to the paving surface), one or more properties of the paving material (e.g., a viscosity or density of the paving material), or a combination thereof, among other examples. The sensors 210 may be configured to output, via the bus 205, signals corresponding to the one or more characteristics of the auger 145, the paving material, and/or the paver 100. For example, when the auger 145 is hydraulically powered, the sensors 210 may include a first hydraulic pressure sensor 210A configured to measure a first hydraulic pressure and a second hydraulic pressure sensor 210B configured to measure a second hydraulic pressure. Alternatively or in addition, one or more of the sensors 210 may be a flow rate sensor configured to measure the flow rate of the hydraulic fluid used to operate the auger 145, an ammeter (e.g., a current sensor) configured to measure a current drawn by an electric auger drive motor 150, a temperature sensor (e.g., a thermocouple or thermal imaging sensor) configured to measure a temperature of the paving material, a force sensor configured to measure a weight of the paving material, a speedometer configured to measure a speed of the paver 100, one or more orientation sensors (e.g., gyroscopes) configured to measure an orientation of the screed plate 115 relative to the paving surface and/or an angle of the paver 100 relative to the paving surface, or a combination thereof, among other examples.

The auger motor controller 215 may include circuitry configured to operate the auger drive motor 150. The auger drive motor 150 may be an electric motor configured to rotate the auger 145. In accordance with one or more control signals output by the auger motor controller 215, the auger drive motor 150 may draw an electric current, which may cause a rotor of the auger drive motor 150 to rotate about a stator of the auger drive motor 150 in accordance with a desired torque, speed, and/or direction. The rotor of the auger drive motor 150 may be connected to a shaft of the auger 145, and rotation of the rotor may cause the auger 145 to rotate. The control signals output by the auger motor controller 215 may correspond to different rotational speeds of the rotor of the auger drive motor 150, and therefore, different rotational speeds of the auger 145. The auger motor controller 215 may output, via the bus 205, a signal indicating the amount of current provided to or drawn by the auger drive motor 150. Alternatively, the auger drive motor 150 may be hydraulically powered, and the auger motor controller 215 may be configured to output one or more control signals that control a hydraulic pressure (or a hydraulic pressure differential) provided to the auger drive motor 150. For example, the auger motor controller 215 may output one or more control signals that regulate the flow of hydraulic fluid to the auger drive motor 150, thereby controlling a speed, torque, and directional operation. The auger motor controller 215 may receive feedback from sensors (e.g., the first hydraulic pressure sensor 210A and/or the second hydraulic pressure sensor 210B) monitoring operating conditions and may adjust one or more hydraulic valve positions or a pump displacement to maintain controlled operation of the auger drive motor 150.

The transceiver 220 may include an antenna, circuitry, or other electronic components configured to transmit and receive data signals. The transceiver 220 may include a transmitter module configured to modulate a data signal for transmission and a receiver module configured to demodulate a received signal. The transceiver 220 may include circuitry that may process and convert data signals for communication purposes and may be integrated a communication system of the paver 100. The transceiver 220 may be configured to obtain signals output by other components of the paver 100 shown in FIG. 2 via the bus 205. The transceiver 220 may be configured to wirelessly communicate with the remote computer 140. For example, the transceiver 220 may be configured to receive data from, transmit data to, or a combination thereof, among other examples, the remote computer 140.

The interface device 225 may include a screen, circuitry, or other electronic components configured to receive an input from and/or present information to an operator of the paver 100. For example, the interface device 225 may include a touch screen that may be configured to receive a user input and receive signals for rendering visual representations of data. The interface device 225 may include control circuitry configured to process user inputs and received signals. In some aspects, the interface device 225 may be positioned, on the paver 100, in view of the operator of the paver 100. The interface device 225 may be configured to receive information such as information about the paver 100, information about the screed plate 115, information about the paving material, or a combination thereof, among other examples. Additionally or alternatively, the interface device 225 may be configured to present, to the operator of the paver 100, a visual representation of the amount of paving material being deposited onto the paving surface.

The memory 230 includes volatile and/or nonvolatile memory, such as random access memory (RAM), read only memory (ROM), a hard disk drive, and/or another type of memory (e.g., a flash memory, a magnetic memory, and/or an optical memory). The memory 230 may include internal memory (e.g., RAM, ROM, or a hard disk drive) and/or removable memory (e.g., removable via a universal serial bus connection). In some implementations, the memory 230 is a non-transitory computer-readable medium. The memory 230 stores information, one or more instructions, and/or software (e.g., one or more software applications) related to the operation of the paver 100. For example, the memory 230 may store information associated with the paver 100, the screed plate 115, or the paving material. The information stored in the memory 230 may be provided via the interface device 225, received from the remote computer 140, provided via the one or more sensors 210, or included in firmware, among other examples. Accordingly, the memory 230 may be configured to store measurements, by the one or more sensors 210, that may be used to determine the mass of the paving material deposited onto the paving surface. In some implementations, the memory 230 includes one or more memories that are coupled (e.g., communicatively coupled) to one or more processors (e.g., processor 235), such as via the bus 205. Communicative coupling between a processor 235 and a memory 230 enables the processor 235 to read and/or process information stored in the memory 230 and/or to store information in the memory 230.

The processor 235 includes a central processing unit, a graphics processing unit, a microprocessor, a controller, a microcontroller, a digital signal processor, a field-programmable gate array, an application-specific integrated circuit, and/or another type of processing component. The processor 235 may be implemented in hardware, firmware, or a combination of hardware and software. The processor 235 may include one or more processors capable of being programmed to perform one or more operations or processes described elsewhere herein.

The processor 235 may be configured to estimate a mass of the paving material deposited onto a paving surface in accordance with the measurements by the one or more sensors 210. The processor 235 may be configured to receive or access, from the memory 230, outputs of the one or more sensors 210, including one or more hydraulic pressure measurements, a flow rate measurement, a motor current measurement, a temperature measurement, a weight measurement, a speed measurement, and orientation measurement, an angle measurement, or a combination thereof, among other examples. The processor 235 may be configured to receive or access, from the memory 230, other information such as one or more properties of the paving material (e.g., a viscosity and/or density), information about the paver 100 (e.g., a weight of the paver 100), information about the auger 145 (e.g., an amount of current drawn by the auger drive motor 150 or an amount of hydraulic pressure used to operate the auger drive motor 150), or a combination thereof, among other examples.

For example, the processor 235 may be configured to access or receive a first hydraulic pressure measured by a first hydraulic pressure sensor and a second hydraulic pressure measured by a second hydraulic pressure sensor. The processor 235 may be configured to determine a drive power (e.g., a torque) of the auger 145 in accordance with a difference between the first hydraulic pressure and the second hydraulic pressure. Alternatively, the processor 235 may be configured to determine the drive power of the auger 145 in accordance with the electric current drawn by the auger drive motor 150. The processor 235 may be configured to estimate the mass of the paving material being deposited onto the paving surface in accordance with the drive power of the auger 145. The processor 235 may be configured to generate the mass indication corresponding to the estimated mass of the paving material. The processor 235 may be configured to output, to the interface device 225, the mass indication representing the mass of the paving material being deposited onto the paving surface. In some aspects, the processor 235 may provide the mass indication to the remote computer 140. The remote computer 140 may be configured to store the mass indication, associate the mass of the paving material being deposited onto the paving surface with a construction site or other indicator, or a combination thereof, among other examples. To provide the mass indication to the remote computer 140, the processor 235 may be configured to cause the transceiver 220 to transmit the mass indication to the remote computer 140.

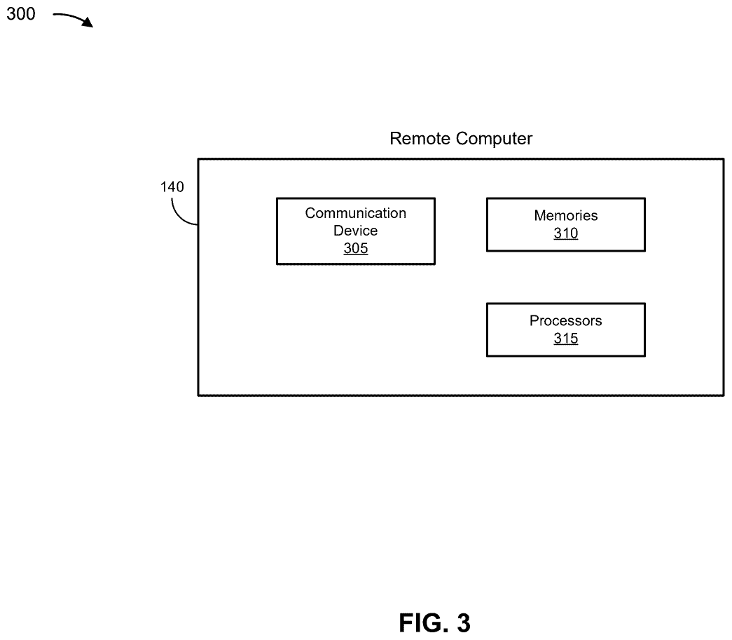

Alternatively, the processor 235 may be configured to receive the mass indication from the remote computer 140. For example, if the processor 235 is not capable of determining the mass indication, the processor 235 may be configured to cause the transceiver 220 to transmit information to the remote computer 140 that may allow the remote computer 140 to calculate the mass of the paving material deposited onto the paving surface. The processor 235 may be configured to receive the mass indication from the remote computer 140 and output the mass indication received from the remote computer 140 to the interface device 225. The processor 235 may be configured to cause the transceiver 220 to transmit the measurements taken by the one or more sensors 210 to the remote computer 140. Additionally, the processor 235 may be configured to cause the transceiver 220 to provide information about the paver 100, the auger 145, or a combination thereof, among other examples, to the remote computer 140. As discussed below with respect to FIG. 3, the remote computer 140 may be configured to determine the mass of the paving material deposited onto the paving surface and transmit the mass indication to the paver 100.

In some implementations, the components of FIG. 2, individually or collectively, may perform one or more operations or processes described herein. For example, a non-transitory computer-readable medium (e.g., memory 230) may store a set of instructions (e.g., one or more instructions or code) for execution by the processor 235. The processor 235 may execute the set of instructions to perform one or more operations or processes described herein. In some implementations, execution of the set of instructions, by one or more processors 235, causes the one or more processors 235 and/or other components of FIG. 2 to perform one or more operations or processes described herein. In some implementations, hardwired circuitry is used instead of or in combination with the instructions to perform one or more operations or processes described herein. Additionally, or alternatively, the processor 235 may be configured to perform one or more operations or processes described herein. Thus, implementations described herein are not limited to any specific combination of hardware circuitry and software.

The number and arrangement of components shown in FIG. 2 are provided as an example. The system 200 may include additional components, fewer components, different components, or differently arranged components than those shown in FIG. 2. Additionally, or alternatively, a set of components or systems 200 (e.g., one or more components or systems 200) may perform one or more functions described as being performed by another set of components or systems 200.

FIG. 3 is a diagram of an example system 300, of a remote computer 140, associated with estimating an amount of paving material being deposited onto a paving surface by a paver 100. As shown in FIG. 3, the remote computer 140 includes a communication device 305, one or more memories 310, and one or more processors 315, among other examples.

The communication device 305 may include computers chips, circuitry, or other electronic components configured to transmit and receive data signals. The communication device 305 may include a transmitter module configured to modulate a data signal for transmission and a receiver module configured to demodulate a received signal. The communication device 305 may include circuitry that may process and convert data signals for communication purposes, such as for communication with the paver 100. The communication device 305 may be configured to obtain signals output by other components of the remote computer 140 shown in FIG. 3. The communication device 305 may be configured to wirelessly communicate with the transceiver 220 of the paver 100. For example, the communication device 305 may be configured to receive data from, transmit data to, or a combination thereof, among other examples, the transceiver 220 of the paver 100. Examples of data received at the remote computer 140 via the communication may include information about the paver 100, information about the screed plate 115 of the paver 100, one or more hydraulic pressure measurements associated with operating the auger 145, one or more electrical current measurements associated with operating the auger 145, the first temperature indication, the second temperature indication, the heat transfer value, the heat transfer factor, the specific heat capacity, or a combination thereof, among other examples.

The memory 310 includes volatile and/or nonvolatile memory, such as RAM, ROM, a hard disk drive, and/or another type of memory (e.g., a flash memory, a magnetic memory, and/or an optical memory). The memory 310 may include internal memory (e.g., RAM, ROM, or a hard disk drive) and/or removable memory (e.g., removable via a universal serial bus connection). In some implementations, the memory 310 is a non-transitory computer-readable medium. The memory 310 stores information, one or more instructions, and/or software (e.g., one or more software applications) related to the operation of the remote computer 140. For example, the memory 310 may store information associated with one or more paving materials, such as one or more viscosities, densities, or a combination thereof, among other examples. The viscosities and densities, among other information, may be stored in a lookup table in the memory 310 of the remote computer 140. The memory 310 may be configured to store other information, such as measurements received from the paver 100, that may be used to determine a mass of the paving material deposited onto the paving surface. The memory 310 may include one or more memories that are coupled (e.g., communicatively coupled) to one or more processors (e.g., processor 315). Communicative coupling between a processor 315 and a memory 310 enables the processor 315 to read and/or process information stored in the memory 310 and/or to store information in the memory 310.

The processor 315 includes a central processing unit, a graphics processing unit, a microprocessor, a controller, a microcontroller, a digital signal processor, a field-programmable gate array, an application-specific integrated circuit, and/or another type of processing component. The processor 315 may be implemented in hardware, firmware, or a combination of hardware and software. The processor 315 may include one or more processors capable of being programmed to perform one or more operations or processes described elsewhere herein.

The processor 315 may be configured to estimate a mass of the paving material deposited onto a paving surface in accordance with the measurements from the paver 100, the information stored in the memory 310, or a combination thereof, among other examples. The processor 315 may be configured to output, to the communication device 305, a mass indication representing the mass of the paving material deposited onto the paving surface, and the communication device 305 may be configured to transmit the mass indication to the transceiver 220 of the paver 100. To determine the mass of the paving material deposited by a paver 100, the processor 315 may be configured to receive or access, from the memory 310, a first hydraulic pressure measurement, a second hydraulic pressure measurement, a difference between the first hydraulic pressure measurement and the second hydraulic pressure measurement, an electric current associated with (e.g., drawn by or provided to) the auger drive motor 150, a flow rate of the hydraulic fluid used to operate the auger 145, a temperature of the paving material, a weight of the paving material, a speed of the paver 100, an orientation of a screed plate 115 relative to a paving surface, an angle of the paver 100 relative to the paving surface, a viscosity of the paving material, or a density of the paving material, among other examples. After determining the mass of the paving material deposited onto the paving surface, the processor 315 may output the mass indication to the communication device 305, and the communication device 305 may transmit the mass indication to the paver 100.

In some implementations, the components of FIG. 3, individually or collectively, may perform one or more operations or processes described herein. For example, a non-transitory computer-readable medium (e.g., memory 310) may store a set of instructions (e.g., one or more instructions or code) for execution by the processor 315. The processor 315 may execute the set of instructions to perform one or more operations or processes described herein. In some implementations, execution of the set of instructions, by one or more processors 315, causes the one or more processors 315 and/or other components of FIG. 3 to perform one or more operations or processes described herein. In some implementations, hardwired circuitry is used instead of or in combination with the instructions to perform one or more operations or processes described herein. Additionally, or alternatively, the processor 315 may be configured to perform one or more operations or processes described herein. Thus, implementations described herein are not limited to any specific combination of hardware circuitry and software.

The number and arrangement of components shown in FIG. 3 are provided as an example. The system 300 may include additional components, fewer components, different components, or differently arranged components than those shown in FIG. 3. Additionally, or alternatively, a set of components or systems 300 (e.g., one or more components or systems 300) may perform one or more functions described as being performed by another set of components or systems 300.

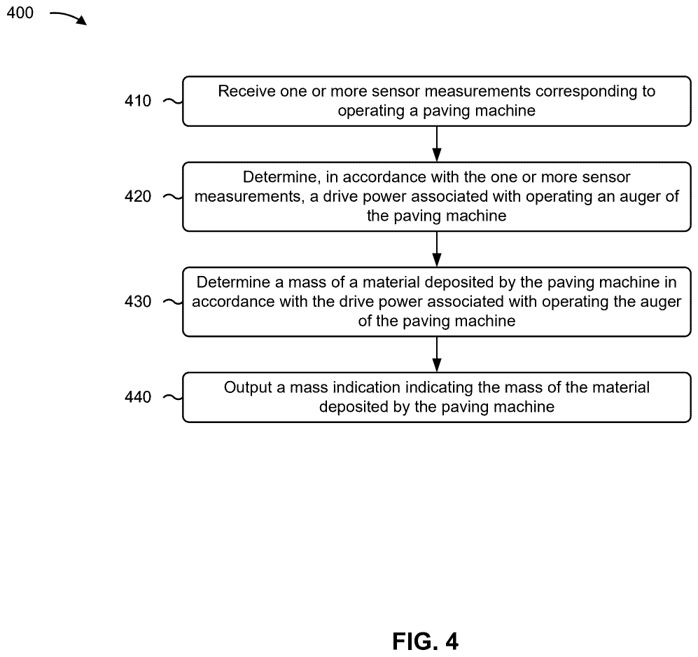

FIG. 4 is a flowchart of an example process 400 associated with estimating an amount of paving material being deposited onto a paving surface based on an auger drive power. One or more process blocks of FIG. 4 may be performed by a paver (e.g., paver 100) or a remote computer (e.g., remote computer 140). Additionally, or alternatively, one or more process blocks of FIG. 4 may be performed by another device or a group of devices separate from or including the paver or the remote computer, such as another device or component that is internal or external to the paver or the remote computer.

As shown in FIG. 4, process 400 may include receiving one or more sensor measurements corresponding to operating a paver (block 410). For example, the paver or remote computer may receive one or more sensor measurements corresponding to operating a paver, as described above. The one or more sensor measurements may include a first hydraulic pressure and a second hydraulic pressure associated with operating the auger, and wherein the drive power is determined in accordance with a difference between the first hydraulic pressure and the second hydraulic pressure. Alternatively or in addition, the one or more sensor measurements may include one or more of a flow rate of a hydraulic fluid used to operate the auger, a motor current, a temperature of a paving material, a weight of the paving material, a speed of the paver, an orientation of a screed plate relative to a paving surface, an angle of the paver relative to the paving surface, or one or more properties of a paving material. The one or more properties of the paving material includes one or more of a viscosity of the paving material or a density of the paving material.

As further shown in FIG. 4, process 400 may include determining, in accordance with the one or more sensor measurements, a drive power associated with operating an auger of the paver (block 420). For example, the paver or remote computer may determine, in accordance with the one or more sensor measurements, a drive power associated with operating an auger of the paver, as described above.

As further shown in FIG. 4, process 400 may include determining a mass of a material deposited by the paver in accordance with the drive power associated with operating the auger of the paver (block 430). For example, the paver or remote computer may determine a mass of a material deposited by the paver in accordance with the drive power associated with operating the auger of the paver, as described above.

As further shown in FIG. 4, process 400 may include outputting a mass indication indicating the mass of the material deposited by the paver (block 440). For example, the paver may output a mass indication indicating the mass of the material deposited by the paver, as described above. Outputting the mass indication may include outputting the mass indication to an interface device. Alternatively or in addition, outputting the mass indication includes transmitting the mass indication to the paver.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The paver, system, or remote computer, individually or collectively, may provide an operator of the paver with real-time estimates of an amount of paving material (e.g., asphalt mixture) that is being deposited onto a paving surface during a paving operation. The estimate is based on operation of an auger. For example, the estimate may be based on a drive power of the auger, and the drive power may be determined in accordance with a hydraulic pressure difference, an electric current drawn by an auger drive motor, or other measurements or characteristics associated with the paver, the auger, or the paving material. When the operator of the paver is provided with a real-time estimate of the amount of paving material being deposited onto the paving surface, the operator can modify, or continue to perform, the paving operation in real time so that the desired amount of paving material is used. Giving the operator information, such as the amount of paving material being deposited, in real time may prevent waste and avoid costly and time-consuming repairs without compromising the quality of the paved surface.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

1. A method, comprising:
receiving one or more sensor measurements corresponding to operating a paver;
determining, during a paving operation and in accordance with the one or more sensor measurements, a drive power used to operate an auger of the paver to move a material from a hopper of the paver toward a screed plate of the paver;
determining, during the paving operation, a mass of the material being deposited onto a paving surface by the paver in accordance with the drive power used to operate the auger; and
outputting, during the paving operation, a mass indication indicating the mass of the material being deposited onto the paving surface by the paver.

2. The method of claim 1, wherein the one or more sensor measurements includes a first hydraulic pressure and a second hydraulic pressure associated with operating the auger, and wherein the drive power is determined in accordance with a difference between the first hydraulic pressure and the second hydraulic pressure.

3. The method of claim 1, wherein the one or more sensor measurements includes one or more of:
a flow rate of a hydraulic fluid used to operate the auger;
a motor current;
a motor speed;
an auger speed;
a temperature of a paving material;
a weight of the paving material;
a speed of the paver;
an orientation of the screed plate relative to the paving surface;
an angle of the paver relative to the paving surface; or
one or more properties of the paving material, wherein the one or more properties of the paving material includes one or more of a viscosity of the paving material or a density of the paving material.

4. The method of claim 1, wherein outputting the mass indication includes outputting the mass indication to an interface device.

5. The method of claim 1, wherein outputting the mass indication includes transmitting the mass indication to the paver.

6. An apparatus, comprising:
a hopper for storing a paving material;
an auger configured to deposit the paving material onto a paving surface;
a conveyor configured to transport the paving material from the hopper to the auger;
a screed plate configured to compact the paving material on the paving surface;
one or more sensors configured to measure one or more sensor values;
an interface device;
one or more memories; and
one or more processors, coupled to the one or more memories, configured to:
determine, during a paving operation, a mass of the paving material being deposited onto the paving surface by the apparatus in accordance with a drive power used to operate the auger to move a material from the hopper toward the screed plate; and
output, during the paving operation to the interface device, a mass indication indicating the mass of the paving material being deposited onto the paving surface by the apparatus.

7. The apparatus of claim 6, wherein the one or more sensors include:
a first hydraulic pressure sensor configured to measure a first hydraulic pressure; and
a second hydraulic pressure sensor configured to measure a second hydraulic pressure,
wherein the first hydraulic pressure and the second hydraulic pressure are associated with operating the auger.

8. The apparatus of claim 7, wherein the one or more processors are configured to determine the drive power in accordance with a difference between the first hydraulic pressure and the second hydraulic pressure.

9. The apparatus of claim 6, wherein the one or more sensors include one or more of:
a flow rate sensor for measuring a flow rate of a hydraulic fluid used to operate the auger;
a current sensor configured to measure a motor current;
a temperature sensor configured to measure a temperature of the paving material;
a force sensor configured to measure a weight of the paving material;
a speedometer configured to measure a speed of a paver; or
one or more orientation sensors configured to measure at least one of an orientation of the screed plate or an angle of the paver relative to the paving surface.

10. The apparatus of claim 6, wherein the drive power is determined in accordance with one or more properties of the paving material,
wherein the one or more properties of the paving material includes one or more of a viscosity of the paving material or a density of the paving material.

11. The apparatus of claim 6, further comprising a transceiver configured to transmit the mass indication to a remote computer.

12. The apparatus of claim 6, further comprising a transceiver configured to:
transmit the one or more sensor values to a remote computer; and
receive the mass indication from the remote computer.

13. The apparatus of claim 12, wherein the one or more processors, to determine the mass of the paving material deposited onto the paving surface, are configured to determine the mass of the paving material deposited onto the paving surface in accordance with the mass indication received from the remote computer.

14. A system, comprising:
one or more memories; and
one or more processors, coupled to the one or more memories, configured to:
receive one or more sensor measurements corresponding to operating a paver;
determine, during a paving operation and in accordance with the one or more sensor measurements, a drive power used to operate an auger of the paver to move a material from a hopper of the paver toward a screed plate of the paver;
determine, during the paving operation, a mass of the material being deposited onto a paving surface by the paver in accordance with the drive power used to operate the auger of the paver; and
output, during the paving operation, a mass indication indicating the mass of the material being deposited onto the paving surface by the paver.

15. The system of claim 14, wherein the one or more sensor measurements includes a first hydraulic pressure and a second hydraulic pressure associated with operating the auger.

16. The system of claim 15, wherein the drive power is determined in accordance with a difference between the first hydraulic pressure and the second hydraulic pressure.

17. The system of claim 15, wherein the one or more sensor measurements includes one or more of:
a flow rate of a hydraulic fluid used to operate the auger;
a motor current;
a motor speed;
an auger speed;
a temperature of a paving material;
a weight of the paving material;
a speed of the paver;
an orientation of the screed plate relative to the paving surface;
an angle of the paver relative to the paving surface; or
one or more properties of the paving material, wherein the one or more properties of the paving material includes one or more of a viscosity of the paving material or a density of the paving material.

18. The system of claim 14, wherein outputting the mass indication includes outputting the mass indication to an interface device.

19. The system of claim 14, wherein outputting the mass indication includes transmitting the mass indication to the paver.

20. The method of claim 1, wherein determining the drive power comprises determining a torque of the auger.
